(19) United States
(12) Patent Application Publication
(10) Pub. No.: US 2014/0209771 A1
(43) Pub. Date: Jul. 31, 2014

(54) MOUSE PAD

(71) Applicants: HONG FU JIN PRECISION INDUSTRY (ShenZhen) CO., LTD., (US); HON HAI PRECISION INDUSTRY CO., LTD., New Taipei (TW)

(72) Inventors: BO TIAN, Shenzhen (CN); KANG WU, Shenzhen (CN); YU HAN, Shenzhen (CN)

(73) Assignees: HON HAI PRECISION INDUSTRY CO., LTD., New Taipei (TW); HONG FU JIN PRECISION INDUSTRY (ShenZhen) CO., LTD, Shenzhen (CN)

(21) Appl. No.: 13/849,547

(22) Filed: Mar. 25, 2013

(30) Foreign Application Priority Data
Jan. 31, 2013 (CN) 201310037508.4

(51) Int. Cl. G06F 3/039

(52) U.S. Cl. CPC G06F 3/0395
USPC 248/346.01

(57) ABSTRACT

A mouse pad includes a supporting plate and a heat-conduction cover mounted on the supporting plate. The supporting plate defines a number of airflow channels communicating with air outlets of a notebook computer.

### BACKGROUND

1. Technical Field

The present disclosure relates to a pad for supporting the mouse.

2. Description of Related Art

Mouse pads are usually made of flexible material, such as plastic, for supporting the mouse. However, if the user operates the mouse in a low temperature environment, the hand of the user may become cold and numb.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawing, all the views are schematic, and like reference numerals designate corresponding parts throughout the several views.

FIG. 1 is an exploded, isometric view of an embodiment of a mouse pad together with a notebook computer, wherein the mouse pad includes a supporting member.

FIG. 2 is an enlarged view of the supporting member of FIG. 1.

FIG. 3 is an assembled, isometric view of FIG. 1, showing the mouse pad in use.

### DETAILED DESCRIPTION

The disclosure, including the accompanying drawings, is illustrated by way of example and not by way of limitation. It should be noted that references to “an” or “one” embodiment in this disclosure are not necessarily to the same embodiment, and such references mean at least one.

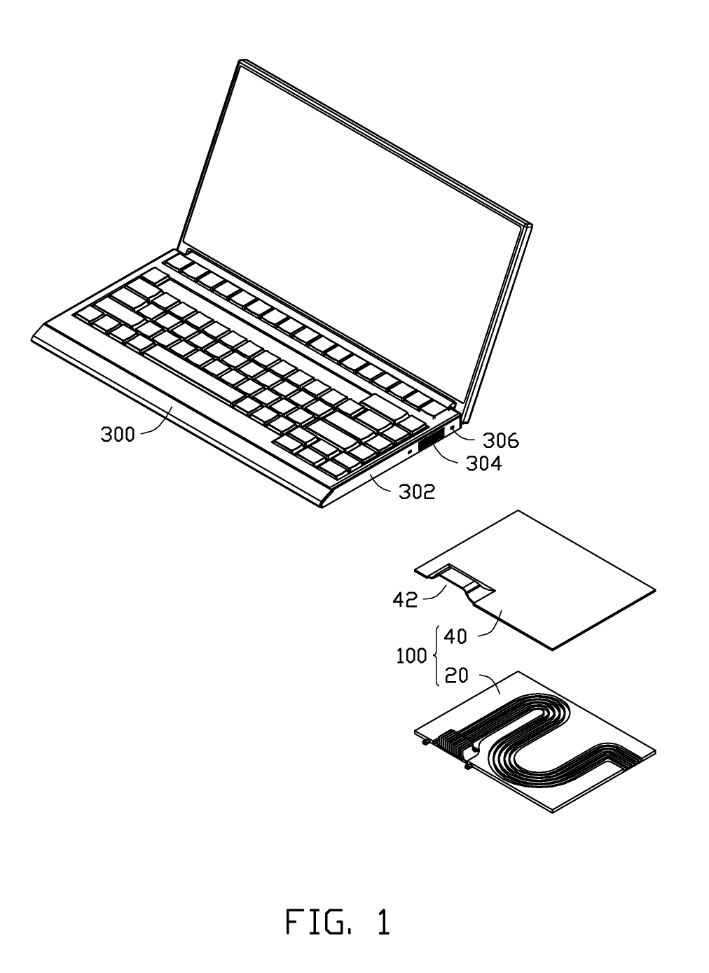

FIG. 1 shows an exemplary embodiment of a mouse pad 100. The mouse pad 100 is used with a notebook computer 300, for supporting a mouse (not shown). The notebook computer 300 includes a sidewall 302. The sidewall 302 defines a plurality of air outlets 304, and two latching holes 306 at opposite sides of the outlets 304.

The mouse pad 100 includes a heat-conduction supporting member 20 and a heat-conduction cover 40.

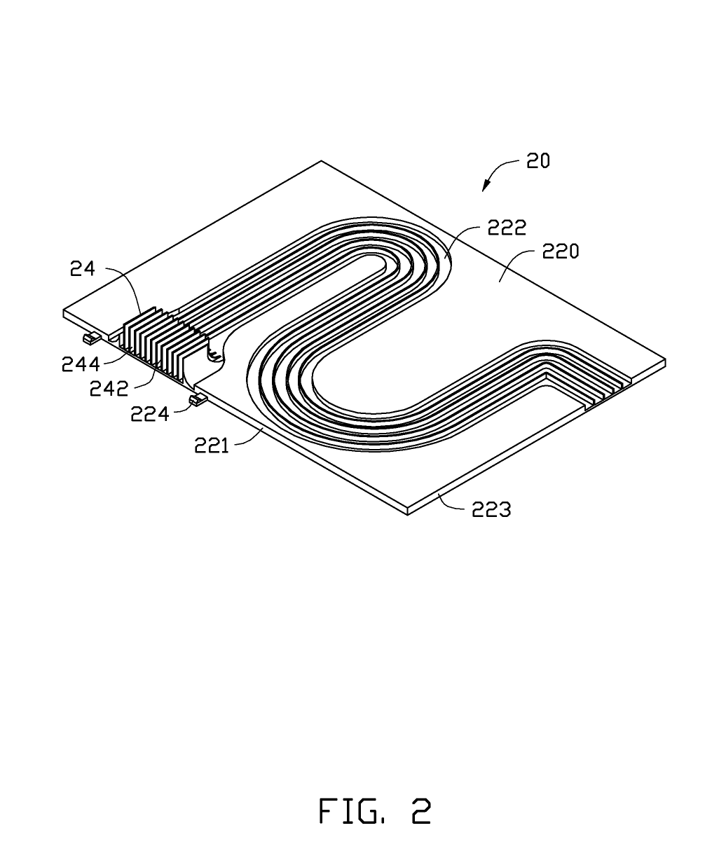

FIG. 2 shows the heat-conduction supporting member 20 including a rectangular supporting plate 220 and a heat absorption portion 24. The supporting plate 220 is made of heat-conduction material, such as steel or copper. The supporting plate 220 includes two opposite sides 221 and two opposite ends 223 connected between the sides 221. The heat absorption portion 24 is located on a top surface of the supporting plate 220, adjacent to one of the ends 223 and one of the sides 221. The heat absorption portion 24 includes a plurality of parallel extending pieces 242 perpendicularly extending up from the supporting plate 220. Every two adjacent extending pieces 242 bound a space 244. The top surface of the supporting plate 220 defines a plurality of tortuous airflow channels 222. A first end of each airflow channel 222 communicates with the corresponding space 244, and a second end of the airflow channel 222 extends through the other end surface 223 away from the heat absorption portion 24. Two hooks 224 protrude out from the side 221 adjacent to the heat absorption portion 24 and are located at opposite sides of the heat absorption portion 24.

The cover 40 is made of heat-conducting material. The cover 40 is substantially rectangular, and a side of the cover 40 defines a receiving portion 42.

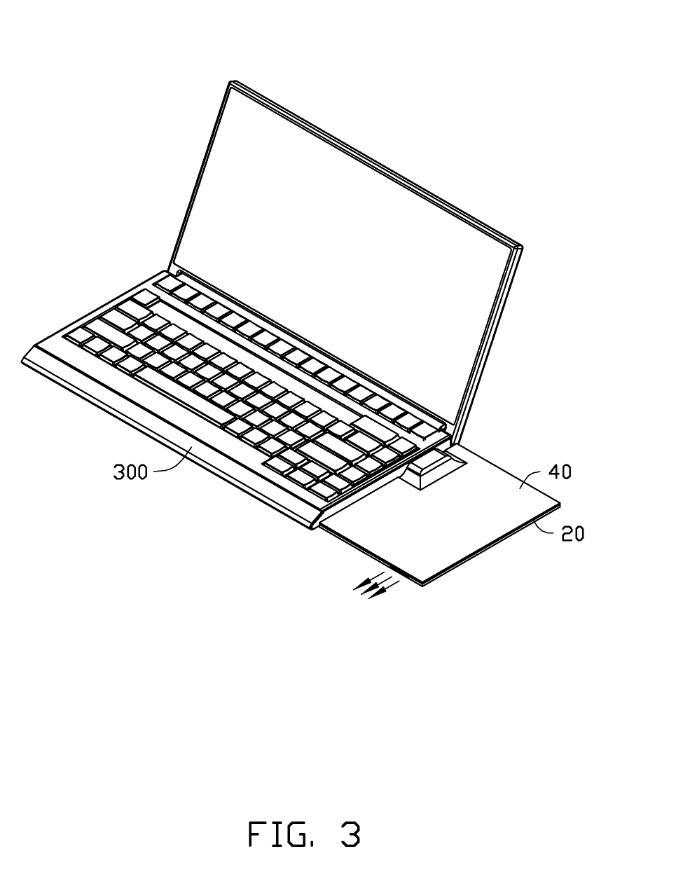

FIG. 3 shows that in assembly, the cover 40 is covered on the top surface of the supporting plate 220, with the heat absorption portion 24 received in the receiving portion 42 of the cover 40. In the embodiment, the cover 40 is mounted on the supporting plate 220 by glue.

In use, the heat absorption portion 24 of the mouse pad 100 is aligned with the air outlets 304 of the notebook computer 300, and the hooks 224 of the mouse pad 100 are inserted into the latching holes 306. The air outlets 304 communicate with the airflow channels 222 of the supporting plate 220 through the spaces 244. The notebook computer 300 generates a great amount of heat in operation. The heat is exhausted through the air outlets 304, and flows through the spaces 244 and the airflow channels 220 of the supporting member 20. The heat is transferred to the cover 40 through the airflow channels 222 and the supporting plate 220. The mouse supported on the mouse pad 100 is warmed, thereby warms the hand of user.

Even though numerous characteristics and advantages of the embodiments have been set forth in the foregoing description, together with details of the structure and the functions of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A mouse pad, comprising:
a supporting plate; and
a heat-conduction cover mounted on the supporting plate;
wherein the supporting plate defines a plurality of airflow channels communicating with air outlets of a computer.

2. The mouse pad of claim 1, wherein the supporting plate comprises a heat absorption portion located between the air outlets of the notebook computer and the airflow channels.

3. The mouse pad of claim 2, wherein the heat absorption portion defines a plurality of spaces communicating with the air outlets and the airflow channels.

4. The mouse pad of claim 3, wherein the heat absorption portion comprises a plurality of parallel extending pieces extending up from the supporting plate, the spaces are bounded by adjacent extending pieces, an end of each airflow channel away from the heat absorption portion extends through an end of the supporting plate.

5. The mouse pad of claim 3, wherein the airflow channels are tortuous, and defined in a top surface of the supporting plate.

6. The mouse pad of claim 2, wherein the heat-conduction cover defines a receiving portion for receiving the heat absorption portion.

7. The mouse pad of claim 1, wherein the cover is mounted to the supporting plate by glue.

8. The mouse pad of claim 1, wherein two hooks protrude out from the supporting plate, to latch to the computer.

9. The mouse pad of claim 1, wherein the supporting plate is made of heat-conduction material.
